(19) United States
(12) Patent Application Publication
(10) Pub. No.: US 2009/0148785 A1
(43) Pub. Date: Jun. 11, 2009

(54) Wet developer having specific temperature characteristics of dynamic viscoelasticity and fixing method using the same

(75) Inventor: Keyaki Yogome, Otsu-shi (JP)

Correspondence Address: BRINKS HOFER GILSON & LIONE, P.O. BOX 10395, CHICAGO, IL, 60610, US

(73) Assignee: Konica Minolta Business Technologies, Inc.

(21) Appl. No.: 12/315,600

(22) Filed: Dec. 3, 2008

(30) Foreign Application Priority Data
Dec. 5, 2007 (JP) 2007-314534
Dec. 7, 2007 (JP) 2007-316740
Sep. 30, 2008 (JP) 2008-254276

(51) Int. Cl. G03G 9/12; G03G 13/20

(52) U.S. Cl. 430/112; 430/124.1; 430/124.3

(57) ABSTRACT

The present invention relates to a wet developer comprising:
a carrier solution;
toner particles dispersed in the carrier solution; and
a dispersing agent for dispersing the toner particles in the carrier solution,
wherein a change in loss elastic modulus in response to a temperature rise of the wet developer has a peak, and
a fixing method for fixing images of toner on a recording material, comprising:
developing electrostatic latent images to form toner images with a wet developer containing a carrier solution, toner particles dispersed in the carrier solution, and a dispersing agent for dispersing the toner particles in the carrier solution, the wet developer having a peak in a change in loss elastic modulus in response to a temperature rise of the wet developer;
transferring the toner images on the recording material; and
fixing the transferred toner images by heat.

This application is based on applications No. 2007-314534, 2007-316740 and 2008-254276, filed in Japan, the contents of which are hereby incorporated by reference.

### BACKGROUND OF THE INVENTION

1. Field of the Invention

The present invention relates to a wet developer formed by dispersing a toner in a carrier solution and a fixing method in which a toner image developed by using the wet developer is transferred onto a recording material and fixed thereon.

2. Description of the Related Art

An image-forming apparatus of an electrophotographic system has been widely used, in which an electrostatic latent image is formed on a photosensitive member (photosensitive drum) and a toner is adhered thereto, and transferred onto a sheet of paper or the like to be fixed thereon. In particular, in image-forming apparatuses in which high quality and high resolution are required, such as office printers and on-demand printing apparatuses used for a large amount of prints, a wet developing system using a wet developer that has a small toner particle size and is less susceptible to toner image disturbance has come to be utilized.

In recent years, an image-forming apparatus has been proposed in which a wet developer having a high viscosity and a high concentration, formed by dispersing a toner as a solid component containing a resin and a pigment, in an insulating solvent (carrier solution) such as fluid paraffin or silicon oil, at a high concentration, is proposed.

Upon carrying out a developing process by using this wet developer, a thin layer of the developer having a thickness in a micron unit is formed on a developer-supporting member such as a developing roller, and in general, this thin developer layer is made in contact with a photosensitive member for development.

A latent image on the surface of the photosensitive member is developed by the thin layer of the wet developer, and a toner image is formed on the surface of the photosensitive member. This toner image is transferred onto a recording material. Alternatively, this is once primary-transferred on an intermediate transfer member or the like, and then secondary-transferred onto a recording material.

The toner image, thus transferred onto the recording material, is pressed and heated by a fixing device so that it is fixed onto the recording material, which is normally prepared as paper. However, since the toner image is developed by using the wet developer that has been originally formed by dispersing a toner in a carrier solution, the carrier solution is contained not only in the toner, but also between toner particles, as well as between toner and paper, and highly viscous.

The presence of the carrier solution with a high viscosity has been known to impair a fixing property upon fixing the toner image. For example, since the toner image and the recording material are brought into wet states by the carrier solution, the fixing property of the toner image is lowered, and a crushed image and an image disturbance tend to occur at the time of a fixing process under pressure.

A technique has been developed in which an attempt is made to remove the solvent (carrier solution) from an unfixed toner image prior to the fixing process.

For example, a heat-generating source is placed before the fixing device so that the solvent on the recording material is evaporated to be removed therefrom. Alternatively, the solvent in the toner image is deposited onto the surface by applying heat thereto, and removed by using a removing means such as a squeezing process. The adhesive strength between the toner and the recording material is increased by applying an electric field thereto. Such various techniques have been proposed.

However, there are various problems, such as a safety problem of the evaporated solvent, an energy increase due to supply of heat of vaporization and the possibility of giving damages to the recording material in the squeezing process and of causing an image disturbance and an image roughness, and it has been difficult to effectively remove the solvent.

The reason for the solvent with a high viscosity to impair the fixing property is related to the fact that, from the viewpoint of storage stability of the wet developer, high dispersibility is required. When the wet developer itself has high dispersibility, the toner particles are hardly made in contact with one another and the joining process hardly progresses at the time of fixing, with the result that the toner layer fails to provide an aggregated and condensed state of toner particles to cause a poor fixing property.

In contrast, when the dispersibility is lowered, toner aggregation tends to occur while the wet developer is stored, and the storage stability might not be maintained.

Consequently, although it is desirable to remove the solvent from the toner layer at the time of fixing, taking it into consideration that the above-mentioned problems are present, it is necessary to examine the wet developer containing the solvent as to such a thermal property as not to impair the fixing property thereof, while maintaining the storage stability. The present inventor has found that, in evaluation of the storage stability and fixing property, the temperature characteristic of dynamic viscoelasticity of the wet developer is effectively used.

In Japanese Patent Application Laid-Open No. 2004-333633, a technique has been proposed in which, with respect to a toner image prior to a thermal transferring process, its dynamic viscoelasticity is measured, and the viscoelasticity is controlled so as to be set in a predetermined range. The controlling method, for example, includes a method in which the temperature is raised by a heater so that the viscoelasticity is changed. Thus, by preliminarily maintaining the toner layer in a predetermined softened state, the toner is fused so that the transferring process can be executed smoothly.

In the case of Japanese Patent Application Laid-Open No. 2004-333633, however, the softening of the toner particles is considered as a main problem, and the dynamic viscoelasticity as the toner is mainly controlled. With respect to the wet developer in which toner particles are dispersed in a solvent, the thermal property of the toner particles is not reflected thereto as it is.

As described above, in the wet developing process, a toner image prior to a fixing process, transferred onto a recording material, contains a carrier solution (solvent) having a considerably high viscosity not only in the toner, but also between toner particles, as well as between the toner and the recording material, with the result that it impairs the fixing property upon fixing the toner image. However, various problems are raised in an attempt to remove the carrier solution.

In order to execute the contacting process among toner particles and the joining process thereof to improve the fixing property even in the presence of the carrier solution between the toner particles as well as between the toner and the recording material, it is effective to lower the dispersibility of the wet developer. In this case, however, the lowering of the dispersibility raises a problem of degradation of the storage stability in the wet developer.

### BRIEF SUMMARY OF THE INVENTION

An object of the present invention is to provide a wet developer that has a characteristic that hardly impairs the fixing property while maintaining good storage stability as the wet developer, and a fixing method using such a wet developer.

The above-mentioned object can be achieved by a wet developer including a carrier solution;

toner particles dispersed in this carrier solution; and

a dispersing agent for dispersing the toner particles in the carrier solution, and in this arrangement, the wet developer is allowed to have such a temperature characteristic that a change in loss elastic modulus G″ in response to a temperature rise of the wet developer forms a peak.

### BRIEF DESCRIPTION OF THE DRAWINGS

FIG. 1 is a drawing that illustrates a schematic structural example of an image-forming unit in a wet image-forming apparatus.

FIG. 2 is a graph that shows an example of a temperature characteristic of a loss elastic modulus G″ in a general wet developer.

FIG. 3 is a graph that shows an example of a temperature characteristic of a loss elastic modulus G″ in a wet developer in accordance with the present invention.

FIG. 4 is a graph that shows an example of a temperature characteristic of a loss elastic modulus G″ where T1 is equal to T2.

FIG. 5 is a drawing that shows a relationship between a target range of a temperature characteristic and the temperature characteristic of each of dispersing agents to be selected.

FIG. 6 is a drawing that shows a structural example of a two-stage fixing device in which fixing processes are carried out twice.

FIG. 7 is a graph that shows an example of a temperature characteristic of a loss elastic modulus G″ in each of wet developers of Examples 1 to 5.

FIG. 8 is a graph that shows an example of a temperature characteristic of a loss elastic modulus G″ in each of wet developers to which each of Examples 1 and 7 is solely applied.

FIG. 9 is a graph that shows an example of a temperature characteristic of a loss elastic modulus G″ in each of wet developers of Examples 8 and 9.

### DETAILED DESCRIPTION OF THE INVENTION

The present invention relates to a wet developer including a carrier solution;

toner particles dispersed in this carrier solution; and

a dispersing agent for dispersing the toner particles in the carrier solution, and in this arrangement, the wet developer is allowed to have such a temperature characteristic that a change in loss elastic modulus G″ in response to a temperature rise of the wet developer forms a peak.

A wet developer is provided to which a specific temperature characteristic, more specifically, a dynamic viscoelasticity, and in particular, a temperature characteristic in loss viscoelasticity, are imparted. With this arrangement, it becomes possible to provide a wet developer that has a characteristic that hardly impairs the fixing property while maintaining proper storage stability as a wet developer, and a fixing method using such a wet developer.

Referring to drawings, the following description explains embodiments according to the present invention.

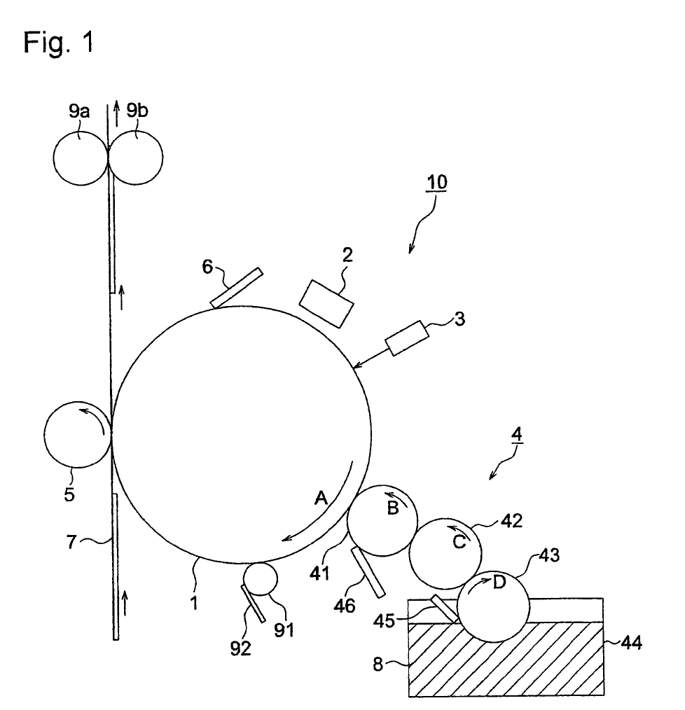

A wet development using a wet developer is applied to an image-forming apparatus, such as a copying machine, a simple printing machine or a printer. In general, an image-forming process of an electrophotographic system is commonly used for these apparatuses. Referring to FIG. 1, first, a wet image-forming unit in accordance with the electrophotographic system is explained, and with respect to a toner image that is developed by using a wet developer and transferred onto a recording material, a relationship between its fixing property and a temperature characteristic of a dynamic viscoelasticity (substituted by a loss elastic modulus) of a wet developer is explained.

(Structure of Image-Forming Unit and its Functional Operations)

Referring to FIG. 1, a structural example of an image-forming unit in an image-forming apparatus in which a wet developer of the present embodiment is used is explained. FIG. 1 is a drawing that shows a schematic structural example of the image-forming unit in the wet image-forming apparatus.

In FIG. 1, reference numeral 1 represents a photosensitive drum that serves as an image-supporting member. An image-forming unit 10 is provided with the following members that are disposed around the photosensitive drum 1 placed in the center, that is, a charging device 2 that uniformly charges the surface of photosensitive drum 1, an exposing device 3 that irradiates the charged photosensitive drum 1 with a LED or a laser beam so that an electrostatic latent image is formed thereon, a wet developing device 4 that develops the electrostatic latent image by using a wet developer, a transferring device 5 that transfers a developed toner image onto a transfer material 7, a cleaning device 6 that removes the wet developer remaining on the surface of photosensitive drum after the transferring process, and the like.

Devices used for preliminarily applying a part of the wet developer and recovering a part thereof may be placed before and after the wet developing device 4 in some cases. Here, a squeeze device 91 used for removing an excessive wet developer from the developed toner image is installed after the wet developing device 4.

The transfer material 7 may be a recording material such as a sheet of recording paper itself, or another structure may be used in which an intermediate transfer belt or the like is used as the transfer material 7, and a transferring process is again carried out onto a recording material. In the present embodiment, explanation will be given as the transfer material 7 being a recording material, that is, a sheet of recording paper (hereinafter, referred to as a recording material 7).

In general, the wet developing device 4 is provided with a developing roller 41 that carries a thin layer of wet developer on its surface, and develops a latent image on the photosensitive drum 1 serving as an image-supporting member, a transporting roller 42 that is made in contact with the developing roller 41 so as to transport the wet developer having its liquid amount adjusted on its surface, and a supply roller 43 that is made in contact with the transporting roller 42 to supply a wet developer 8 in a developer vessel 44 onto its surface. The supply roller 43 is an anilox roller, and makes a regulating blade 45 in contact with the peripheral face of the supply roller 43 so that the amount of supply of the wet developer is regulated. Reference numeral 46 represents a cleaning blade used for cleaning the peripheral face of the developing roller 41 that has passed through a developing nip.

In FIG. 1, only the single wet developing device 4 is placed; however, a plurality of them may be placed for color image formation. The system for color developing processes and the presence or absence of an intermediate transferring process may be optionally determined, and the corresponding desired structural layout may be prepared.

The photosensitive drum 1 is rotated in a direction of arrow A shown in FIG. 1, and the charging device 2 charges the surface of the rotating photosensitive drum 1 to about several hundred volts by corona discharge or the like. On the downstream side in the rotation direction of the photosensitive drum from the charging device 2, an electrostatic latent image whose surface potential has been lowered to about one hundred volts or less by a laser beam applied by the exposing device 3 is formed.

The wet developing device 4 is placed on the further downstream side of the exposing device 3, and the electrostatic latent image formed on the photosensitive drum 1 is developed by using the wet developer 8.

The wet developer 8 formed by dispersing a toner in an insulating solvent (hereinafter, referred to also as a carrier solution) is housed in the developer vessel 44, and the wet developer 8 is supplied to the surface of transporting roller 42 by the supply roller 43.

The transporting roller 42 transports a thin layer of the wet developer 8 to be transferred onto the developing roller 41. A thin layer of the wet developer 8 is supported on the developing roller 41. Toner particles inside the thin layer of the wet developer 8 supported on the developing roller 41 are shifted onto the electrostatic latent image on the photosensitive drum 1 by a potential difference between the developing roller 41 and the electrostatic latent image on the photosensitive drum 1 so that the electrostatic latent image is developed.

The toner image developed on the photosensitive drum 1 contains the toner and the carrier solution. The squeeze device 91, which is prepared, for example, as a squeeze roller, removes the excessive carrier solution from the developed toner image. The carrier solution on the squeeze roller is removed by a blade 92.

The transferring device 5 (for example, a transferring roller) applies a charge or a voltage to the recording material 7 that is transported at the same velocity as the peripheral velocity of the photosensitive drum 1, so that the developed toner image on the photosensitive drum 1 is transferred onto the recording material 7.

On the downstream side of the transferring device 5, the cleaning device 6 (for example, a cleaner blade) used for removing the wet developer 8 remaining on the surface of photosensitive drum 1 is disposed. The wet developer 8 remaining on the photosensitive drum 1 is removed by the cleaning device 6.

The recording material 7 on which the toner image has been transferred by the transferring device 5 is transported to a fixing device formed by a pair of fixing rollers 9a and 9b, subjected to heating and fixing processes, and discharged.

(Composition of Developer)

The wet developer 8 to be used for developing is explained. The wet developer 8 is formed by dispersing colored toner particles in a carrier solution serving as a solvent at a high concentration. Additives, such as a dispersing agent and a charge-controlling agent may be added to the wet developer 8, if necessary.

An insulating solvent that is non-volatile at normal temperature is used as the carrier solution. Examples of the non-volatile solvent include insulating oil, for example, general fluid paraffin, such as Moresco White® or Isopar, and silicon oil.

The toner particles are mainly formed of a resin and a pigment or a dye used for coloring. The resin has a function for allowing the pigment or dye to be uniformly dispersed therein, and a function as a binder used for the fixing process on a recording material.

Examples of the resin include thermoplastic resins, such as a polystyrene resin, a styrene-acrylic resin, an acrylic resin, a polyester resin, an epoxy resin, a polyamide resin, a polyimide resin and a polyurethane resin. A plurality of these resins may be mixed with one another to be used.

As the pigment and dye used for coloring the toner, those generally commercially available may be used. Examples of the pigment include carbon black, iron oxide red, titanium oxide, silica, Phthalocyanine Blue, Phthalocyanine Green, Sky Blue, Benzidine Yellow and Lake Red D. Examples of the dye include Solvent Red 27 and Acid Blue 9.

Generally-used oil-soluble dispersing agents may be used as the dispersing agent, and a more detailed explanation will be given later.

The wet developer may be prepared by using a generally-used technique. For example, a resin and a pigment are mixed at a predetermined compounding ratio, and melt-kneaded by using a pressure kneader, a roll mill, or the like, to be uniformly dispersed, and the resulting dispersed matter is finely pulverized with, for example, a jet mill. The resulting fine powder is classified by using, for example, an air classifier so that a colored toner having a predetermined particle size can be obtained.

The resulting toner is mixed with an insulating oil serving as a carrier solution at a predetermined compounding ratio. This mixture is uniformly dispersed by using a dispersing means such as a ball mill so that a wet developer can be obtained.

The volume average particle size of the toner is desirably set in the range from 0.1 μm or more to 5 μm or less. When the average particle size of the toner is lower than 0.1 μm, developing properties are seriously lowered. In contrast, when the average particle size of the toner exceeds 5 μm, the image quality is lowered.

The ratio of the mass of the toner particles relative to the mass of the wet developer is preferably set in the range from 10 to 50%. In the case of less than 10%, the toner particles tend to easily precipitate, resulting in a problem with long-term storage stability with time. Moreover, in order to obtain a required image concentration, a large amount of developer needs to be supplied, and the carrier solution to adhere to the sheet of paper consequently increases, with the result that a drying process is required upon fixing to cause vapor to generate, resulting in an environmental problem. In the case of 50% or more, the viscosity of the wet developer becomes too high to cause difficulties in production and handling.

The viscosity of the wet developer is preferably set to 0.1 mPa·s or more to 10000 mPa·s or less at 25° C. In the case of 10000 mPa·s or more, it becomes difficult to stir the carrier solution and the toner, causing high loads in preparing devices to obtain a uniform wet developer.

(Dynamic Viscoelasticity of Wet Developer and its Temperature Characteristics)

In accordance with the present invention, both of the fixing property and the storage stability can be controlled by controlling the temperature characteristics of dynamic viscoelasticity of the wet developer.

With respect to the dynamic viscoelasticity of the wet developer, it sometimes becomes difficult to carry out measurement with high precision depending on a viscosity range. In the present embodiment, the loss elastic modulus G″, which can be measured with high precision, is used as a substitute characteristic. The following explanation will be given based upon the loss elastic modulus; however, the storage elastic modulus, or another index representing the dynamic viscoelasticity, may, of course, be used.

The measurement of the loss elastic modulus was carried out by using a rheology characteristic evaluation apparatus (rotation-type Rheometer), ARES-RFS made by TA Instruments Co., Ltd. A 50-mm parallel plate was used as the plate, and the measuring conditions were set to 1 mm gap, 10 Hz frequency, 5% strain and 10° C./min rate of temperature rise.

<Normal Temperature Characteristic>

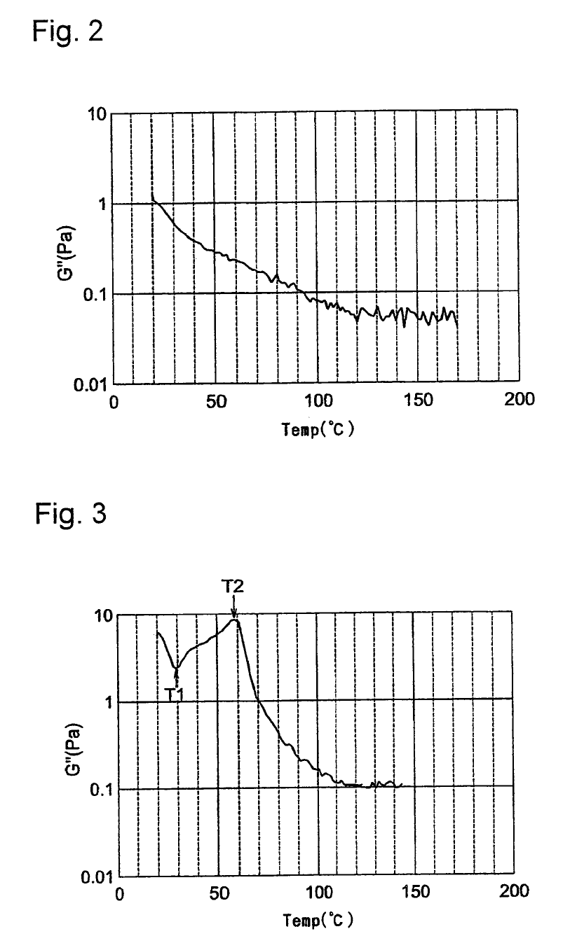

FIG. 2 shows a temperature characteristic of the loss elastic modulus G″ in a conventional non-volatile wet developer. As the temperature of the wet developer rises, the loss elastic modulus is monotonically lowered smoothly. That is, as the temperature rises, the viscoelasticity becomes lower, and the developer subsequently becomes softer. This characteristic is caused by the characteristic of the carrier solution to a considerable degree, and considered to indicate the dispersibility of toner particles in the carrier.

That is, the smooth monotonous reduction of the loss elastic modulus in FIG. 2 is considered to reflect the loss elastic modulus of the carrier solution, and consequently to indicate that the wet developer maintains high dispersibility. Therefore, this wet developer hardly causes aggregation of toner particles, and has good storage stability.

Think about the following case where a toner image, developed by using such a wet developer as above, is fixed. The toner image prior to the fixing process contains a carrier solution having high viscosity among the toner particles to form the toner image, as well as between the toner particles and a recording material.

The wet developer is allowed to have considerably high dispersibility by using a dispersing agent or the like, by taking the storage stability into consideration, so as not to cause aggregation of toner particles or the like during its storage. In the case of a wet developer having a good fixing property, its dispersibility is gradually lowered as the temperature used for the fixing operation is raised, with the result that the mutual contact and aggregation among the toner particles take place. That is, the fixing property is successfully maintained. However, in the case of a wet developer having a poor fixing property as shown in FIG. 2, the dispersibility is hardly lowered even by the temperature rise, and the fusing temperature of the toner is attained prior to the occurrence of the mutual contact and aggregation among the toner particles.

In this manner, the change in dispersibility generally corresponds to a change in loss elastic modulus, that is, to the temperature characteristic. The specific relationship of these will be described later from the viewpoint of a peak in temperature characteristic.

A problem arises in that the ensuring the fixing property and the storage stability have a trade-off relationship as described above. In an attempt to ensure a good fixing property, the dispersibility should be sacrificed, resulting in a failure in ensuring sufficient storage stability. In contrast, in an attempt to ensure a good storage stability, the dispersibility should be ensured to a higher level, making the fixing property easily impaired.

The wet developer is desirably designed to have such a temperature characteristic that high dispersibility (a high loss elastic modulus), which hardly causes toner aggregation or the like at a storing temperature, is maintained, while ensuring low dispersibility (a low loss elastic modulus upon separation between the carrier solution and the toner layer) that easily causes the aggregation of toner particles to be integrally joined with one another at a fixing temperature.

<Temperature Characteristic Having Peak>

FIG. 3 shows an example of a temperature characteristic of loss elastic modulus G″ with respect to the wet developer that can satisfy both of storage stability and fixing property, as described above. In the present embodiment, the loss elastic modulus G″ is used; however, originally, the dynamic viscoelasticity is used as described earlier. The storage elastic modulus, or another index representing the dynamic viscoelasticity, may, of course, be used.

The present inventor made various investigations on the temperature characteristic in the loss elastic modulus of a wet developer, and consequently have found that the degree of trade-off between the storage stability and the fixing property is changed depending on whether or not there is a peak in the temperature characteristic of the loss elastic modulus. Referring to FIG. 3, the feature of the temperature characteristic by which both of the storage stability and the fixing property are satisfied is explained.

In FIG. 3, the loss elastic modulus is monotonously lowered at first as the temperature of a wet developer rises. However, the lowering of the loss elastic modulus is deterred at a temperature lower than the fixing temperature, and the loss elastic modulus again starts to rise at a temperature T1. The rise of the loss elastic modulus is then stopped at a temperature T2 near a fixing temperature, and thereafter, the loss elastic modulus is monotonously lowered continuously. That is, a peak is formed at the temperature T2.

The following description explains what this change in loss elastic modulus at the peak means.

The temperature T1 is a temperature at which the dispersibility is lowered, that is, a temperature at which toner particles are made in contact with one another to start forming an aggregation. Therefore, when the storage stability of the wet developer is taken into consideration, the wet developer is desirably stored at a temperature that is sufficiently lower than T1. That is, when T1 is set at a sufficiently high temperature, the storage stability becomes better.

When the temperature rises beyond T1, the loss elastic modulus, which has been lowered, starts rising. This is considered to be influenced by the progress of the toner aggregation. The loss elastic modulus is not only dependent on the carrier solution, but also related to a relationship with the toner that is being aggregated, and the loss elastic modulus consequently continues to rise.

When the temperature has reached T2, the loss elastic modulus stops rising, and starts going down. This is because the toner has been virtually aggregated to be integrally joined to one another, and virtually separated from a carrier solution. Consequently, the loss elastic modulus is again changed depending only on the carrier solution. That is, it is monotonously lowered continuously in response to a temperature rise.

As described above, it is found that the temperature T2 corresponds to a state in which the toner has aggregated sufficiently. It becomes possible to increase the fixing strength by utilizing this toner aggregation. Therefore, when the toner fixing strength is taken into consideration, the fixing process is required to be carried out at this temperature T2 or a temperature higher than the temperature T2. That is, when T2 is a sufficiently low temperature, a sufficient fixing strength can be obtained at a lower fixing temperature.

<Fixing Property, Storage Stability and Temperature Characteristics T1, T2>

From the viewpoint of trade-off between the fixing property and storage stability, the higher the rising temperature T1, the better the storage stability, and the lower the peak temperature T2, the better the fixing property. Because of T1≦T2, as the temperature T1 becomes closer to the temperature T2, and as the temperature T2 also becomes closer to the temperature T1, both of the storage stability and the fixing property can be satisfied more properly.

In the present embodiment, the loss elastic modulus G″ is adopted as a substitute characteristic for the dynamic viscoelasticity. Specific examples of the temperatures T1 and T2 that contribute to the fixing property and the storage stability in this case are shown below (concerning the composition of a wet developer and process conditions for toner image formation and fixing processes, as well as evaluation methods for the fixing property and storage stability, see examples to be described later).

When the temperature T1 exceeds 40° C., and preferably, exceeds 55° C., the storage stability becomes better.

When the temperature T2 does not exceed 130° C., and preferably, is lower than 100° C., the fixing property becomes better.

That is, from the viewpoint of both of the storage stability and fixing property, the wet developer is preferably designed to satisfy the following relationship: 40° C.<T1≦T2<130° C., more preferably, relationship: 55° C.<T1≦T2<100° C.

<Temperature Characteristic of T1=T2>

In the explanation of the temperature characteristic having a peak in FIG. 3, it has been described that as T1 becomes closer to T2, and as T2 also becomes closer to T1, both of the storage stability and the fixing property can be satisfied. That is, as long as T1≦T2, it is desirable to satisfy T1=T2.

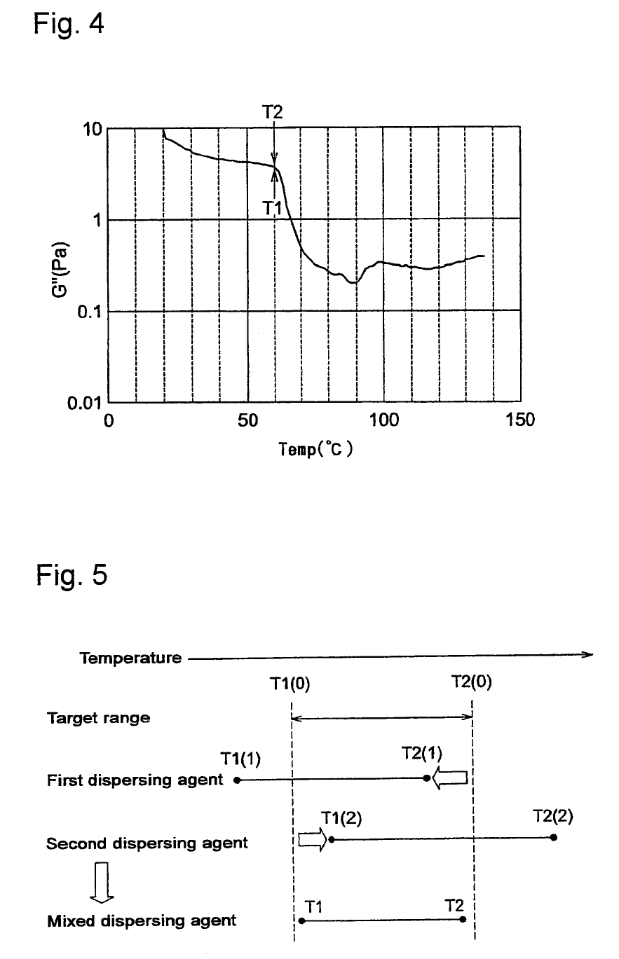

However, when T1=T2 is satisfied, both of the expression that the loss elastic modulus starts rising at the temperature T1 and the expression that a peak is formed at the temperature T2 lack validity. Therefore, by taking it into consideration that T1 and T2 have come closer to each other to be brought into an ultimate state, a temperature characteristic as shown in FIG. 4 is referred to as a temperature characteristic of T1=T2.

FIG. 4 shows an example of the temperature characteristic of the loss elastic modulus G″ corresponding to T1=T2. While coming closer to T1, the loss elastic modulus tries to rise, but is kept from rising. During this period, a stable aggregating state (supposed to be a soft aggregated state) is exerted in which the toner aggregation continues within such a range as not to affect the loss elastic modulus. Upon reaching a point corresponding to T1 and also to T2, the aggregated toner quickly changes to a state separated (fixing state) from the carrier solution, and the loss elastic modulus that has been suppressed starts lowering quickly, with the peak being attained. Since such a behavior of the loss elastic modulus G″ in response to a temperature rise can be distinguished positively from the behavior of the loss elastic modulus G″ in response to a normal temperature rise shown in FIG. 2, such a behavior of the temperature characteristic of the loss elastic modulus G″ at the time of T1=T2 as shown in FIG. 4 shall also be included in the concept that “the temperature characteristic in which a change in loss elastic modulus G″ in response to a temperature rise forms a peak” in the present invention.

This is considered to be derived from the fact that in the wet developer, the temperature T1 at which toner particles start aggregating with one another and the temperature T2 at which the toner has been aggregated and integrally joined with one another to complete the fusing are extremely close to each other. If so, this state is the most desirable state from the viewpoint of satisfying both of the storage stability (in which T1 is desirably set to a higher temperature) and the fixing property (in which T2 is desirably set to a lower temperature) simultaneously.

Controlling Method for Temperature Characteristic>

In the present invention, by intentionally controlling the temperature characteristic of the loss elastic modulus in a wet developer so that a specific temperature characteristic is imparted to the wet developer, the corresponding good storage stability and fixing property can be achieved.

The controlling of the loss elastic modulus can be carried out by controlling dispersibility by the use of a dispersing agent. That is, the kind and amount of the dispersing agent to be added to the wet developer are appropriately selected so that the dispersibility of the wet developer is controlled. The dispersibility is controlled so that high dispersibility is exerted at a low temperature by taking the storage stability into consideration while low dispersibility is exerted at a high temperature by taking the fixing property into consideration. Upon selecting the dispersing agent, the adsorbing group, the compatible group and the molecular weight thereof are mainly taken into consideration. These factors respectively give influences to adsorbing property to particles, solubility to the carrier solution and diffusivity of the dispersing agent. The adsorbing group is desirably selected by taking into consideration its acidic/basic property, hydrogen bond and the like depending on the polarity of toner surface. For example, in the case when the toner contains an ester resin, since there is a —COOH group on the terminal to exhibit an acidic property, it is preferable that the dispersing agent has a basic adsorbing group. The compatible group needs to be appropriately selected depending on carrier solution molecules. The molecular weight is preferably selected based upon solubility and diffusivity to the carrier solution. As the molecular weight becomes higher, the solubility and diffusivity to the carrier solution are lowered so that, although it becomes difficult to allow the dispersing agent to adhere to the toner surface uniformly, a stable adsorbing property is exerted after the adhesion. As the molecular weight becomes lower, the dispersing agent is liable to be dissolved and readily produced; however, the diffusivity becomes higher, and the dispersibility consequently tends to be lowered. Therefore, as the dispersing agent that exerts stable dispersibility at a low temperature, while exerting low dispersibility at a high temperature, those dispersing agents that exhibit a strong adsorbing property to the toner at a low temperature, while dissociating from the toner at a high temperature, are desirably used. From these viewpoints, it is important to select the kinds and the number of the adsorbing groups, as well as the kinds, the lengths and the molecular weights of the compatible groups. However, since there is a possibility that a phenomenon that does not match general rules might occur, it is important to select the dispersing agent based upon experiments.

Since its temperature characteristics are dependent on the temperature characteristics of the dispersing agent, it is important to properly determine the kind and the amount of addition of the dispersing agent.

As the dispersing agent, preferable examples thereof include a polymer dispersing agent having, as its adsorbing group, an amino group (primary to tertiary), an aromatic amine such as a pyridinium group, pyrrolidone, imines, polyimines, —COOH, —SO₃H, —OH, a carbonyl group, an ether group, an epoxy group, an ester group, an amide group, or a salt of these. Preferable examples of the compatible group, those having a hydrocarbon chain, a hydroxy hydrocarbon chain, a polyester chain, a polyamide chain or the like. A plurality of these adsorbing groups and compatible groups are preferably included in a molecule. Bonding types of these include a comb type, a pendant type, a single type and a star type, and among these, in particular, the comb type and the pendant type are preferably used. By selecting the adsorbing groups and the compatible groups from a plurality of combinations thereof, characteristics over a wide range can be obtained. With respect to the molecular weight, in general, those in the range of from 2000 to 10000 are preferably used, while depending on the adsorbing group and the compatible group.

Preferable examples thereof include Solsperse® S11200, S13940, S19000 and S36000, made by Lubrizol Corporation, V216, V220 and WP 550, made by ISP Co., Ltd., and BYK-116 made by BYK Chemie Co., Ltd. More preferably, Solsperse® S13940, V216 and V220 may be used.

The amount of addition of the dispersing agent is set to 0.5 to 2.0 parts by weight, preferably 0.5 to 1.5 parts by weight, relative to 100 parts by weight of the toner. When the amount of addition is too high, the dispersibility becomes too high even at a high temperature, and consequently tends to cause degradation of the fixing property. When the amount of addition is too low, the viscosity of the wet developer becomes too high, and consequently tends to cause a difficulty in handling. However, the amount of addition is not necessarily limited to the above-mentioned range, and is varied depending on the molecular weight, molecular weight distribution, dispersing ability, adsorbing property, amounts of impurities and the like with respect to the dispersing agent, and it is important to determine an appropriate amount of addition depending on the dispersing agent.

In order to obtain an appropriate temperature characteristic, a mixture of a plurality of kinds of dispersing agents may be preferably used. When two kinds of dispersing agents that exert different temperature characteristics when used alone respectively are properly mixed, a preferable temperature characteristic can be obtained more easily.

(Temperature Characteristic Control by Mixing Two Kinds of Dispersing Agents)

The following description explains control of temperature characteristics by mixing a plurality of kinds (two kinds in this case) of dispersing agents having different temperature characteristics.

By using the two kinds of dispersing agents, the temperature characteristic of the loss elastic modulus, characterized by the rising temperature T1 and the peak temperature T2, is appropriately controlled so that a wet developer, which satisfies both of the fixing property and the storage stability, can be obtained.

In the case of using two kinds of dispersing agents also, the temperature characteristic of the loss elastic modulus G″ is set so as to satisfy the following relationship:

40° C.<T1≦T2<130° C.,

more preferable relationship:

55° C.<T1≦T2<100° C.

By using two kinds of dispersing agents, it becomes possible to make T1 further closer to T2, that is, to a state where T1=T2, which has been already explained. With this arrangement, by simultaneously satisfying the condition that T1 is set to a higher temperature so as to make the storage stability better and the condition that T2 is set to a lower temperature so as to make the fixing property better to a maximum degree, the range of selection for achieving both of good storage stability and fixing property can be widened.

In order to achieve the target temperature characteristics, a plurality of dispersing agents are appropriately selected, and their appropriate amounts of addition are determined. In this case, suppose that two kinds of dispersing agents are selected and mixed. One of the dispersing agents is selected from those dispersing agents capable of maintaining stable dispersibility even at a high temperature, while the other dispersing agent is selected from those dispersing agents having slightly low dispersibility that are aggregated at a high temperature, and the amounts of addition of these are appropriately set so that the temperature characteristics can be controlled properly. More specifically, upon making selection from a plurality of similar dispersing agents, a dispersing agent having a higher molecular weight, more adsorbing groups and stronger adsorbing groups may be selected for the former, while a dispersing agent having a lower molecular weight, less adsorbing groups and weaker adsorbing groups may be selected for the latter.

The dispersing agent can be selected on demand from the above-mentioned dispersing agents to be used, and when using two kinds of dispersing agents, a dispersing agent that can not be used when only one kind of dispersing agent is used, that is, a dispersing agent that does not have a peak in the loss elastic modulus G″ even in response to a temperature rise as defined by the present invention, or a dispersing agent that has been difficult to use from the relationship with the fixing temperature, although it has a peak, may be applied. For example, Solsperse® S19000, made by Lubrizol Corporation, may be used as such a dispersing agent.

The amounts of two kinds of dispersing agents may be set so that the total amount thereof is set in the aforementioned range of the amount of use to be applied upon using one kind of dispersing agent.

Preferable combinations of two kinds of dispersing agents include, for example, a combination of Solsperse® S11200 and S13940, a combination of Solsperse® S11200 and S1900, and a combination of Solsperse® S13940 and S19000.

<Selection of Dispersing Agents Having Different Temperature Characteristics>

Two kinds of dispersing agents to be mixed are preferably the ones having mutually different temperature characteristics. This is because even if two kinds of dispersing agents having similar temperature characteristics are mixed, normally, only the same temperature characteristic is obtained, with the result that only the similar effects to those obtained by using either one kind of the dispersing agents are obtained. Of course, no limitation is given to the use of such two kinds of dispersing agents.

When two kinds of dispersing agents are mixed and used, the resulting major technical effect is that a third temperature characteristic that is different from either of the temperature characteristics of the two dispersing agents can be achieved. That is, in the case when the temperature characteristics are represented by the rising temperature T1 and the peak temperature T2, the following first dispersing agent and second dispersing agent are listed as the two kinds of dispersing agents to be mixed.

Supposing that, with respect to a wet developer using only the first dispersing agent at a predetermined concentration as the dispersing agent, a rising temperature relative thereto is set to T1(1), with a peak temperature relative thereto being set to T2(1), and

supposing that, with respect to a wet developer using only the second dispersing agent at a predetermined concentration as the dispersing agent, a rising temperature relative thereto is set to T1(2), with a peak temperature relative thereto being set to T2(2), the first dispersing agent and the second dispersing agent are selected so that the temperature T1(1) and the temperature T1(2) are made different from each other, while the temperature T2(1) and the temperature T2(2) are also made different from each other.

<Selection of Combination of Temperature Characteristics for Achieving the Target>

It has been described that those dispersing agents having mutually different temperature characteristics (the temperature T1 and the temperature T2 in this case) are required for the first dispersing agent and the second dispersing agent to be mixed, and for this purpose, with respect to candidate dispersing agents, it is necessary to preliminarily examine the respective temperature characteristics (T1 and T2) of a wet developer to be exerted when each of the dispersing agents is used therein independently.

In this case, with respect to the first dispersing agent and the second dispersing agent, those dispersing agents are preferably used, which have such temperature characteristics that a rising temperature T1(1) and a peak temperature T2(1) of the loss elastic modulus G″ in a wet developer containing 1 part by weight of only the first dispersing agent (in this case, “only” means only either one of the first dispersing agent and the second dispersing agent) relative to 100 parts by weight of a toner and a rising temperature T1(2) and a peak temperature T2(2) of the loss elastic modulus G″ in a wet developer containing 1 part by weight of only the second dispersing agent (in this case, “only” has the same meaning as described above) relative to 100 parts by weight of a toner, have a temperature difference of 5° C. or more between the temperature T1(1) and the temperature T1(2), as well as between the temperature T2(1) and the temperature T2(2). When the temperature difference is smaller than 5° C., it becomes difficult to sufficiently obtain the technical characteristic to make the temperature control easier. When the temperature difference becomes too large, the influence of one of the dispersing agents is exerted too strongly, resulting in a problem that the developer becomes more susceptible to influences of an error in the amounts of addition. The upper limit of the temperature difference is about 25° C.

With a temperature characteristic being obtained with respect to each of the dispersing agents alone, the combination of temperature characteristics of the first dispersing agent and the second dispersing agent may be determined to obtain target temperature characteristics. This is achieved by the following idea.

First, suppose that there are target temperatures T1(0) and T2(0) as target temperature characteristics. With respect to these, the temperature T1 and the temperature T2, obtained by a dispersing agent formed by mixing the first dispersing agent and the second dispersing agent, are put in the range of the temperature T1(0) and the temperature T2(0).

That is, the following relationship is satisfied:

T1(0)≦T1≦T2≦T2(0)

This relationship is divided into T1(0)≦T1 and T2≦T2(0) to be examined.

In order to satisfy T1(0)≦T1, what relationship needs to be held between T1(1) and T1(2). The present inventor has considered that, since a dispersing agent, formed by mixing the first dispersing agent having a characteristic of T1(1) and the second dispersing agent having a characteristic of T1(2), exerts a characteristic of T1, at least either one of T1(1) and T1(2) should have a temperature of T1(0) or more. If both of these have temperatures lower than T1(0), the characteristic T1 of the mixed dispersing agent never becomes a temperature of T1(0) or more.

Therefore, either one of T1(1) and T1(2), that is, at least the higher of the two, should have a temperature that is T1(0) or more.

Concerning T2≦T2(0), the same is true when the high temperature and the low temperature are reversed.

That is, either one of T2(1) and T2(2), that is, at least the lower of the two, should have a temperature that is T2(0) or less.

FIG. 5 shows a schematic example of the above-mentioned temperature relationship. An actual example is given by portions of T1(0)≦T1(2) and T2(1)≦T2(0), indicated by arrows. Of course, the relationships between the first dispersing agent and the second dispersing agent may be reversed. In such a case, the relationships, T1(0)≦T1(1) and T2(2)≦T2(0), hold.

Satisfying these conditions is a necessary condition, and the mixed dispersing agent is not necessarily placed within the target range, that is, is not necessarily allowed to satisfy T1(0)≦T1≦T2≦T2(0), only by these conditions. Specific values of the temperature characteristics of the first dispersing agent and the second dispersing agent, as well as ratios of the respective amounts of addition and the like, need to be adjusted.

By adopting this control method, it becomes easy to obtain the target characteristic. The reason for this is because T1 and T2 in the dispersing agent that has been obtained by mixing can be controlled independently.

In the case when a single dispersing agent is used, or in the case when even a plurality of dispersing agents are used in a state where those agents have similar temperature characteristics, even if the temperature characteristic can be changed by properly designing the amounts of addition and the like, it is still difficult to control T1 and T2 independently. Increasing the amount of addition too much causes adverse effects to the charging property of a toner or the like.

The above-mentioned method for mixing a plurality of dispersing agents having mutually different temperature characteristics makes it possible to easily control T1 and T2 independently as temperature characteristics, and it is not necessary to greatly change the amounts of addition of the dispersing agents, and only small amounts are required.

<Adaptation to Multi-Stage Fixing Processes>

The wet developer having the above-mentioned temperature characteristics is a developer suitably used for multi-stage fixing processes. The multi-stage fixing processes relate to a fixing method in which, in order to improve the fixing property, a normally used fixing process is carried out a plurality of times.

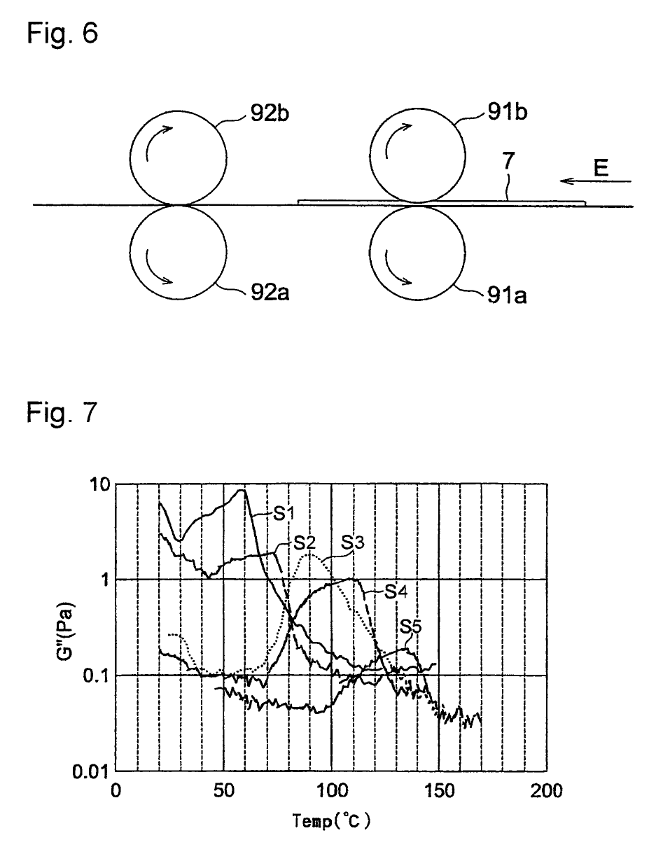

FIG. 6 shows an example of a two-stage fixing device in which fixing processes are carried out twice so as to execute a fixing operation. Reference numerals 91a and 91b represent a pair of fixing rollers in the first stage, and a recording material 7 carrying a toner image prior to a fixing process is transported in a direction of arrow E, and allowed to pass between these two rollers so that the toner image is heated to be subjected to a fixing operation in the first stage.

In the case when a fixing process of a toner image is carried out by using the wet developer of the present embodiment, upon passing through the fixing rollers in the first stage, the toner particles are aggregated to be integrally joined to one another, and separated from a carrier solution.

Upon passing through a pair of rollers 92a, 92b in the second stage, the aggregated and integrated toner image is further heated so that a fixing operation in the second stage is carried out.

The toner particles are further integrated to be finally fixed onto the recording material 7. Moreover, the carrier solution, isolated therefrom in the first stage, serves as a peeling solution so that the integrated toner layer is prevented from being, offset.

In the case of a toner image using not the wet developer of the present embodiment, but a wet developer having a normal temperature characteristic as shown in the example of FIG. 2, even after the fixing processes of the two stages, the integrally joining process of the toner-layer is insufficient, failing to provide a sufficient fixing strength. Moreover, the separation of the carrier solution in the fixing operation in the first stage is insufficient to easily cause offsetting in the fixing operation in the second stage.

### EXAMPLES

The wet developer as described above was prepared, and its fixing property and storage stability were evaluated through actual image-forming processes, and examples thereof are shown below.

In the following examples, the term “part(s)” refers to “part(s) by weight”.

Preparation of Wet Developer>

Respective wet developers used in the following examples and comparative examples were produced by the following processes.

To 100 parts of a polyester resin (Taffton® made by Kao Corp. (Tg: 65° C., Tm: 135° C.)) was added 15 parts of carbon black (Mogul L, made by Cabot Corporation), and the mixture was kneaded by using a kneader so as to be dispersed, and dry-pulverized so that a toner coarsely-pulverized particles were formed.

Fluid paraffin (Moresco White® P40 (made by Matsumura Oil Research Corp.)) was used as a carrier solution.

The carrier solution (80 parts), the coarsely-pulverized particles (20 parts) and a predetermined amount of a dispersing agent were wet-pulverized in a sand mill to prepare a wet developer. The volume-average particle size of the toner was set to 2 to 3 μm.

The dispersing agent used here and its amount of addition (indicated by parts by weight relative to 100 parts of the toner) are shown in the following Tables 1 and 2, for each of examples and comparative examples.

As the dispersing agents shown in Tables 1 and 2, S11200, S19000, S13940, V220, a dispersing agent a, and a dispersing agent b were used.

Dispersing agent S11200: Basic polymer dispersing agent (made by Lubrizol Corporation)

Dispersing agent S19000: Basic polymer dispersing agent (made by Lubrizol Corporation)

Dispersing agent S13940: Basic polymer dispersing agent (made by Lubrizol Corporation)

Dispersing agent V220: Basic polymer dispersing agent (made by ISP Co., Ltd.)

The dispersing agents a and b were produced by using the following processes.

Production of Dispersing Agent A (Basic Dispersing Resin A)

To 100 parts of Moresco White® P40 (made by Matsumura Oil Research Corp.) were added 30 parts of lauryl methacrylate, indicated by Chemical Formula (1), 5 parts of N-vinyl-2-pyrrolidone, indicated by Chemical Formula (2), serving as a basic monomer, and 0.2 parts of azobisisobutyronitrile serving as a polymerization initiator, under a nitrogen atmosphere, and allowed to react with one another at a reaction temperature in the range from 60 to 70° C. for about 12 hours so that a basic dispersing resin a, made from a basic nitrogen-containing heterocyclic compound, was obtained.

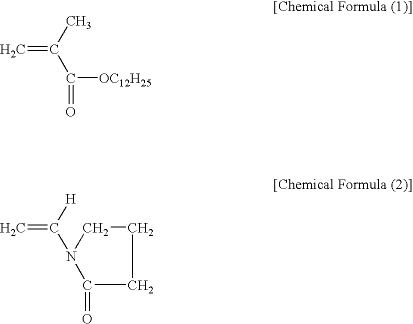

Production of Dispersing Agent B (Basic Dispersing Resin B)

The same preparation processes as those of the dispersing resin a were carried out except that stearyl methacrylate (30 parts) shown in Chemical Formula (3) was used in place of lauryl methacrylate in the preparation of the dispersing resin a, so that a basic dispersing resin b was obtained.

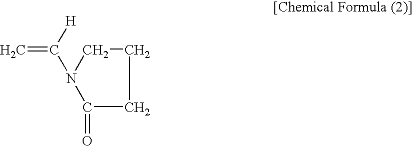

<Measurement on Temperature Characteristic of Loss Elastic Modulus>

The temperature characteristic of the loss elastic modulus G″ of a wet developer was measured for each of examples and comparative examples.

The measurement of the loss elastic modulus was carried out by using a rheology characteristic evaluation apparatus (rotation-type Rheometer), ARES-RFS made by TA Instruments Co., Ltd. A 50-mm parallel plate was used as the plate, and the measuring conditions were set to 1 mm gap, 10 Hz frequency, 5% strain and 10° C./min rate of temperature rise. The measuring temperature range was set to 20 to 140° C. or 50 to 170° C.

From the temperature characteristic thus measured, the aforementioned rising temperature T1 and peak temperature T2 were found. The results of the respective examples and comparative examples are shown in Tables 1 and 2.

<Image-Forming Process Conditions>

By using an image-forming apparatus having a structure shown in FIG. 1, a toner image was formed for each of the wet developers, and subjected to a fixing process. The image-forming process conditions are shown below.

The system speed was set to 400 mm/s, and a negatively chargeable OPC was used as a photosensitive member. The charging potential of the photosensitive member was set to −700 v, the developing voltage was set to −450 v, and the transfer voltage was set to +600 v.

<Evaluation Method for Fixing Property>

A toner image was formed by using the above-mentioned processes, and then fixed, and the resulting fixed sample was subjected to a fixing property test.

The sample was formed on a sheet of woodfree paper/coat paper as a solid pattern (10 cm×10 cm, amount of adhesion: 2 mg/m²) for each of the examples and comparative examples, and subjected to a heat-roller fixing process (180° C.×nip time 80 ms).

In addition to a normal heat-roller fixing process, a multi-stage fixing process (two-stage fixing process), as shown in FIG. 6, was also carried out.

With respect to each of the samples, an offset-free portion was selected, and this portion was rubbed twice with a rubber eraser (sand eraser “LION26111”, made by Lion Office Products Corp.) under a pressing load of 9.8 N so that the residual rate of the image concentration was measured by an “X-Rite model 1404” made by X-Rite Corp.; thus, the evaluation was ranked in the following four-grade criterion. The permissible range is Δ or more.

⊙: Image concentration residual rate was 90% or more;

◯: Image concentration residual rate was from 80% or more to less than 90%;

Δ: Image concentration residual rate was from 70% or more to less than 80%; and

x: Image concentration residual rate was less than 70%.

The results of the fixing property test for each of the examples and the comparative examples are shown in Tables 1 and 2.

<Evaluation Method for Storage Stability>

The wet developer of each of the examples and the comparative examples was subjected to a test for storage stability.

Each of the developers was put in a sample bottle to virtually a half level, and stored for 6 months at room temperature (20 to 26° C.). Thereafter, each of them was visually observed to confirm the presence or absence of precipitation.

Each of them was confirmed as to whether or not it was re-dispersed when shaken to be mixed, or as to whether or not it was re-dispersed when stirred by a spatula. The evaluation was ranked in the following four-grade criterion. The permissible range is Δ or more.

⊙: No precipitation occurred;

◯: Re-dispersed when shaken to be mixed;

Δ: Re-dispersed when stirred by a spatula; and

x: Re-dispersion was not available.

The results of the storage stability test for each of the examples and the comparative examples are also shown in Tables 1 and 2.

TABLE 1

| | | | | Temperature | | | | | |
|---|---|---|---|---|---|---|---|---|---|
| | | | | characteristic of | | | | | |
| | Wet developer | | | elastic modulus | | | Fixing property | | |
| | Dispersing | Amount of | Toner | | T1 | T2 | Single | Multi- | Storage |
| | agent | addition | concentration | Peak | (° C.) | (° C.) | stage | stage | stability |
| Example 1 | S13940 | 1% | 20% | Yes | 30 | 59 | ⊙ | ⊙ | Δ |
| Example 2 | Dispersing | 1% | 20% | Yes | 42 | 60 | ⊙ | ⊙ | ◯ |
| | agent a | | | | | | | | |
| Example 3 | Dispersing | 1% | 20% | Yes | 60 | 90 | ⊙ | ⊙ | ⊙ |
| | agent b | | | | | | | | |
| Example 4 | V220 | 2% | 20% | Yes | 70 | 110 | ◯ | ◯ | ⊙ |
| Example 5 | Dispersing | 3% | 20% | Yes | 96 | 135 | Δ | ◯ | ⊙ |
| | agent b | | | | | | | | |
| Example 6 | S11200 | 1% | 20% | Yes | 79 | 111 | Δ | ◯ | ⊙ |
| Example 7 | S19000 | 1% | 20% | Yes | 33 | 60 | ⊙ | ⊙ | Δ |
| Comparative | S11200 | 3% | 20% | No | — | — | X | X | ⊙ |
| Example 1 | | | | | | | | | |

Example 1 relates to a state in which the temperature characteristic of the loss elastic modulus of a wet developer had a peak. In this case, T1=30° C., T2=59° C., and the fixing property was ⊙. The storage stability was Δ, and was within a permissible range.

Comparative Example 1 relates to a sample in which the temperature characteristic of the loss elastic modulus of a wet developer had no peak. There were no temperatures corresponding to T1 and T2. The fixing property was x.

FIG. 3 shows a temperature characteristic of the loss elastic modulus G″ of Example 1. As shown in FIG. 3, the wet developer of Example 1 had clear peaks in its temperature characteristic so that both of the fixing property and storage stability could be satisfied.

A temperature characteristic of the loss elastic modulus G″ of Comparative Example 1 is shown by FIG. 2. As shown in FIG. 2, the wet developer of Comparative Example 1 had no clear peaks in its temperature characteristic, failing to provide a good fixing property. Although multi-stage fixing operations were executed thereon, it was not possible to obtain a good fixing property, and in contrast, offsets occurred.

In this manner, when the temperature characteristic of the loss elastic modulus has peaks, it is possible to obtain good fixing property and storage stability.

Any of Examples 2 to 7 relate to samples in which, while the temperature characteristic of the loss elastic modulus has peaks, the rising temperature T1 and the peak temperature T2 are respectively different depending on the kinds and amounts of dispersing agents.

Upon noting the temperature T1, when T1 exceeds 40° C., as in the case of Example 2, the storage stability is improved from Δ to ◯. When T1 exceeds 55° C., as in the case of Example 3, further superior storage stability (⊙) is obtained.

Upon noting the temperature T2, a good fixing property (⊙) is obtained up to Example 3; however, when T2 exceeds 100° C. as in the case of Example 4, the fixing property is lowered from ⊙ to ◯. When T2 exceeds 130° C. as in the case of Example 5, the fixing property is further lowered (Δ).

Even when maintained within these permissible ranges, the fixing property varies depending on the temperatures T1 and T2. That is, as described earlier, as the temperature T1 becomes higher, the storage stability becomes better, while, as the temperature T2 becomes lower, the fixing property becomes better.

By way of reference, FIG. 7 shows the temperature characteristic of the loss elastic modulus G″ relating to each of the wet developers of Examples 1 to 5. The respective lines S1 to S5 correspond to the respective temperature characteristics of Example 1 to Example 5.

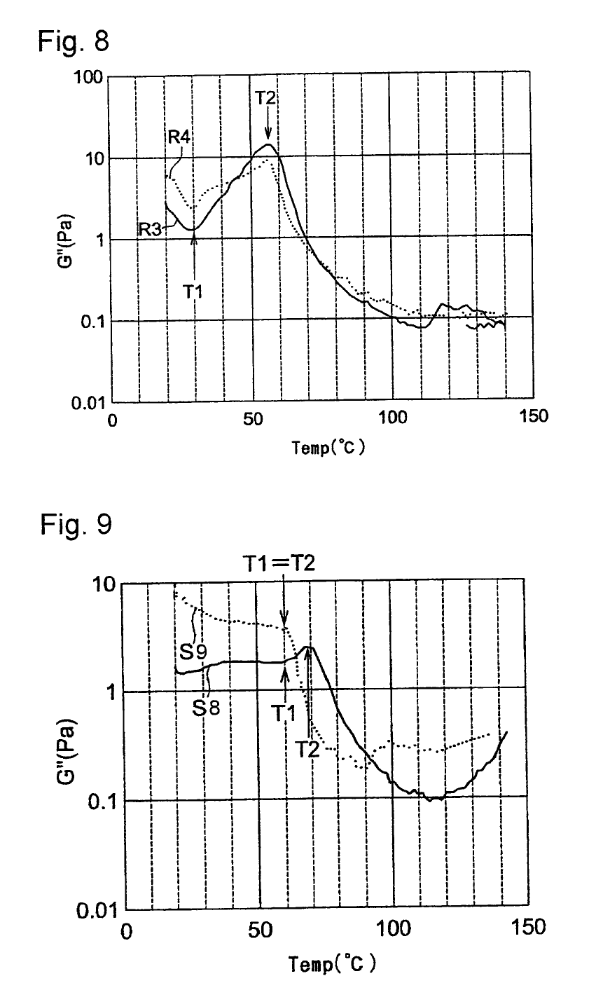

FIG. 8 shows the temperature characteristics of the loss elastic modulus G″ relating to the respective wet developers of Example 1 and Example 7. R3 and R4 respectively show the temperature characteristics of Example 7 and Example 1. Both of rise and peak exhibit virtually the same temperature characteristic, and the temperatures T1 and T2 are almost the same. In this case, the developer of Example 1 using 1 part of the dispersing agent 13940 and the developer of Example 7 using 0.5 parts of the dispersing agent 13940 and 0.5 parts of the dispersing agent S19000 exhibit virtually the same tendency in their characteristics (fixing property and storage stability).

<Selection of Combination of Dispersing Agents>

First, by setting 55° C.<T1≦T2<100° C. as a target, a combination of the dispersing agent b and S13940 was selected from the candidate dispersing agents, and by slightly changing the combination of the amounts of addition, dispersing agents of Examples 8 and 9 were prepared. These two kinds of dispersing agents have mutually different temperature characteristics, and at least T1 of either one of these was a temperature higher than 55° C. and at least T2 of either one of these was a temperature lower than 100° C.

Even when used alone, the dispersing agent b exerts a good fixing property and storage stability (see Table 1). Therefore, it looks meaningless to mix it with another dispersing agent; however, the aim is to make T1 and T2 further close to each other, that is, to make them closer to the state of T1=T2.

Next, by setting 40° C.<T1≦T2<130° C. as a target, a combination of S11200 and S13940 and a combination of S11200 and S19000 were selected from the candidate dispersing agents so that dispersing agents of Examples 10 and 11 were prepared. These two kinds of dispersing agents have mutually different temperature characteristics, and at least T1 of either one of these was a temperature higher than 40° C. and at least T2 of either one of these was a temperature lower than 130° C.

Table 2 shows the results of Examples 8 to 11. By mixing two kinds of dispersing agents, these examples tried to put T1 and T2 within a target range, make T1 and T2 closer to each other, and further optimize the two dispersing agents.

TABLE 2

| | | | | Temperature | | | | | |
|---|---|---|---|---|---|---|---|---|---|
| | | | | characteristic of | | | | | |
| | Wet developer | | | elastic modulus | | | Fixing property | | |
| | Dispersing agent | Amount of | Toner | | T1 | T2 | Single | Multi- | Storage |
| | (first, second) | addition | concentration | Peak | (° C.) | (° C.) | stage | stage | stability |
| Example 8 | Dispersing | 0.5%, 0.8% | 20% | Yes | 60 | 68 | ⊙ | ⊙ | ⊙ |
| | agent b, S13940 | | | | | | | | |
| Example 9 | Dispersing | 0.6%, 0.4% | 20% | Yes | 60 | 60 | ⊙ | ⊙ | ⊙ |
| | agent b, S13940 | | | | | | | | |
| Example 10 | S11200, S13940 | 0.5%, 0.5% | 20% | Yes | 50 | 66 | ⊙ | ⊙ | ◯ |
| Example 11 | S11200, S19000 | 0.5%, 0.5% | 20% | Yes | 51 | 72 | ⊙ | ⊙ | ◯ |
| Example 12 | S13940, S19000 | 0.5%, 0.5% | 20% | Yes | 31 | 62 | ⊙ | ⊙ | Δ |

FIG. 9 shows temperature characteristics of the loss elastic modulus G″ of the respective wet developers of Examples 8 and 9. Lines of S8 and S9 respectively indicate the temperature characteristics of Example 8 and Example 9.

In both of Examples 8 and 9, T1 and T2 are made closer to each other in comparison with a state in which each of the original dispersing agents is used alone. In Example 8, the aggregation of toner particles progresses, and after the loss elastic modulus G″ has risen at T1 from a virtually constant state, it abruptly drops at T2. In Example 9, T1 is equal to T2, and the loss elastic modulus G″ is gradually lowered down to T2; and, it abruptly drops at T2. This corresponds to the aforementioned case where T1 is equal to T2, and its state is considered to satisfy both of the fixing property and the storage stability at high levels.

The dispersing agent b used in Examples 8 and 9 was evaluated as ⊙ in both of the fixing property and the storage stability even when used alone; however, a difference between T1 and T2 was 30° C. (see Table 1) Although evaluated as ⊙ in the same manner, Examples 8 and 9 make it possible to set the difference between T1 and T2 within a very narrow range, that is, 8° C. and 0° C. Thereby, the storage stability at a high temperature is improved by setting T1 higher, and the fixing property at a low temperature is improved by setting T2 lower; thus, both of them can be satisfied.

In Examples 10 and 11, the temperatures T1 are slightly lower, that is, set to 50° C. and 51° C. in comparison with those of Examples 8 and 9. Correspondingly, the storage stability is evaluated not as ⊙, but as ◯. However, these are within a permissible range, and a good fixing property (⊙) is obtained.

As described above, in accordance with the wet developer of the present embodiment, since it is allowed to have such a temperature characteristic that a change in loss elastic modulus in response to a temperature rise of the wet developer forms a peak, the aggregation of mutual toner particles thermally progresses at a fixing temperature predominantly, thereby making it possible to provide a higher toner-layer strength.

With this arrangement, it is possible to provide a wet developer that has a characteristic that hardly impairs the fixing property while maintaining good storage stability as the wet developer. The wet developer is suitably applicable to multi-stage fixing processes so that a fixing method that suitably matches the corresponding wet developer can be provided.

The present embodiments are to be considered in all respects as illustrative and not restrictive. The scope of the invention is indicated by the appended claims rather than by the foregoing description, and all the changes which come within the meaning and range of equivalency of the claims are therefore intended to be embraced therein.

What is claimed is:

1. A wet developer comprising:
a carrier solution;
toner particles dispersed in the carrier solution; and
a dispersing agent for dispersing the toner particles in the carrier solution,
wherein a change in loss elastic modulus in response to a temperature rise of the wet developer has a peak.

2. The wet developer of claim 1, wherein temperature characteristics of the loss elastic modulus satisfies the following relationship:
40° C.<T1≦T2<130° C.
in which T1 is a temperature at which the loss elastic modulus rises up in response to the temperature rise; T2 is a temperature at which the loss elastic modulus shows the peak.

3. The wet developer of claim 2, wherein the temperature characteristics of the loss elastic modulus satisfies the following relationship:
55° C.<T1≦T2<100° C.

4. The wet developer of claim 1, wherein the dispersing agent comprises a first dispersing agent and a second dispersing agent which is different from the first dispersing agent.

5. The wet developer of claim 4, wherein the first dispersing agent and the second dispersing-agent have such temperature characteristics that a rising temperature T1(1) of the loss elastic modulus in a wet developer containing 1% of the first dispersing agent only is 5° C. or more different from a rising temperature T1(2) of the loss elastic modulus in a wet developer containing 1% of the second dispersing agent only.

6. The wet developer of claim 4, wherein the first dispersing agent and the second dispersing agent have such temperature characteristics that a peak temperature T2(1) of the loss elastic modulus in a wet developer containing 1% of the first dispersing agent only is 5° C. or more different from a peak temperature T2(2) of the loss elastic modulus in a wet developer containing 1% of the second dispersing agent only.

7. A fixing method for fixing images of toner on a recording material, comprising:
developing electrostatic latent images to form toner images with a wet developer containing a carrier solution, toner particles dispersed in the carrier solution, and a dispersing agent for dispersing the toner particles in the carrier solution, the wet developer having a peak in a change in loss elastic modulus in response to a temperature rise of the wet developer;
transferring the toner images on the recording material; and
fixing the transferred toner images by heat.

8. The fixing method of claim 7, wherein the fixing is executed through multi-stage fixing processes by heat.

9. The fixing method of claim 8, wherein the multi-stage fixing processes by heat are executed by a plurality of pairs of rollers.
